(19) United States
(12) Patent Application Publication
(10) Pub. No.: US 2004/0156007 A1
(43) Pub. Date: Aug. 12, 2004

(54) Substrate for liquid crystal display and liquid crystal display having the same

(75) Inventors: Yoshiaki Maruyama, Kawasaki (JP); Hiroyasu Inoue, Kawasaki (JP); Yoshinori Tanaka, Kawasaki (JP); Katsushige Asada, Kawasaki (JP)

Correspondence Address: Patrick G. Burns, Esq., GREER, BURNS & CRAIN, LTD., Suite 2500, 300 South Wacker Drive, Chicago, IL, 60606, US

(73) Assignee: FUJITSU DISPLAY TECHNOLOGIES CORPORATION

(21) Appl. No.: 10/737,182

(22) Filed: Dec. 16, 2003

(30) Foreign Application Priority Data
Dec. 17, 2002 (JP) 2002-364665

(51) Int. Cl. G02F 1/1333

(52) U.S. Cl. 349/158

(57) ABSTRACT

The invention relates to a liquid crystal display used in a display section of an electronic apparatus and a substrate for a liquid crystal display used in the same and provides a liquid crystal display and a substrate for a liquid crystal display used in the same which are manufactured with improved yield and which can achieve high display quality. A configuration includes a sealing material forming region which is provided in a peripheral portion of a glass substrate and in which a sealing material is formed and a cell gap control layer which is formed inside the sealing material forming region and which controls a cell gap.

### BACKGROUND OF THE INVENTION

1. Field of the Invention

The present invention relates to a liquid crystal display used in a display section of an electronic apparatus and a substrate for a liquid crystal display used in the same and, more particularly, to a liquid crystal display having a relatively small cell gap and a substrate for a liquid crystal display used in the same.

2. Description of the Related Art

A liquid crystal display has two substrates which are combined together with a sealing material applied to peripheral portions thereof and a liquid crystal sealed between the two substrates. A liquid crystal display also has spherical spacers or pillar spacers for maintaining a predetermined cell gap.

Spherical spacers are constituted by plastic beads that are substantially equal in diameter. Spherical spacers are distributed in a panel by spraying them on one of two substrates using a wet spray method or a dry spray method prior to a combining step at which the substrates are combined. On the contrary, pillar spacers are made of a photosensitive resin and are formed using a photolithographic process in arbitrary positions on one of substrates with an arbitrary distribution density.

A sealing material is plotted and formed using a dispenser. A known method for achieving reliable sealing is a technique in which a planarizing film made of an acrylic resin is removed in a part of the region where the sealing material is formed (see Patent Document 1, for example).

Further, a known method of providing a relatively small cell gap is a technique in which a stripe pattern of a thermally fused material is formed on each of opposite surfaces of two substrates and in which the two substrates are combined such that the stripe patterns form a grid (see Patent Document 2, for example).

Patent Document 1: JP-A-2001-337334

Patent Document 2: JP-A-S57-70521

Patent Document 3: JP-A-H4-320473

For example, the cell gap of a liquid crystal display utilizing a ferroelectric liquid crystal must be as small as about 1.0 to 1.5 μm. In the configurations disclosed in JP-A-2001-337334 and JP-A-S57-70521, it is difficult to reduce the width of the picture-frame of a liquid crystal display when the cell gap is small because the sealing material spreads with a great width when the two substrates are combined. In order to reduce the width of the picture-frame of a liquid crystal display having a small cell gap, the amount of a sealing material ejected from a dispenser must be small. However, when the amount of the sealing material ejected is too small, it is difficult to control the amount of the material ejected from the dispenser. Thus, the sealing material cannot be uniformly applied to the peripheral portions of the substrates, which can result in leakage of the liquid crystal attributable to breakage of the seal. A problem therefore arises in that the yield of manufacture of liquid crystal displays is reduced.

In the case of a liquid crystal display utilizing a ferroelectric liquid crystal, irregularities in the alignment of the liquid crystal attributable to disturbances are fatal, and display abnormalities resulting from the alignment irregularities cannot be recovered without taking some measures. For example, when the cell gap fluctuates because of a pressure exerted on the display screen from the outside, the alignment of the liquid crystal is disturbed, and a problem arises in that there will be visually perceptible display abnormalities (display irregularities) that cannot be recovered without taking some measures.

Especially, when spherical spacers are used, it is difficult to disperse the spherical spacers throughout a substrate uniformly. In the case of a liquid crystal display in which spherical spacers are not uniformly distributed in the panel, the cell gap is apt to fluctuate when a pressure is applied to the substrate surface from the outside.

Further, in an environment at a relatively low temperature (in the range from about −20° C. to about −10° C.), bubbles are generated in the panel because a change in the internal volume of the panel is smaller than a change in the volume of the liquid crystal attributable to contraction. Since the alignment of the liquid crystal is disturbed by the bubbles thus generated, a problem arises in the liquid crystal display utilizing a ferroelectric liquid crystal in that there will be visually perceptible display abnormalities that cannot be recovered without taking some measures.

### SUMMARY OF THE INVENTION

It is an object of the invention to provide a liquid crystal display and a substrate for a liquid crystal display used in the same which are manufactured with improved yield and which allows high display quality.

The above-described object is achieved by a substrate for a liquid crystal display, characterized in that it has a sealing material forming region provided in a peripheral portion of the base substrate and a cell gap control layer formed inside the sealing material forming region and controlling a cell gap between the base substrate and an opposite substrate provided opposite to the base substrate.

### BRIEF DESCRIPTION OF THE DRAWINGS

FIG. 1 shows a schematic configuration of a liquid crystal display in a mode for carrying out the invention;

FIG. 2 shows an equivalent circuit of a TFT substrate of the liquid crystal display in the mode for carrying out the invention;

FIG. 3 shows a configuration of a liquid crystal display panel of the liquid crystal display in the mode for carrying out the invention;

FIG. 4 is a sectional view showing a configuration of a major part of the liquid crystal display panel of the liquid crystal display in the mode for carrying out the invention;

FIG. 5 is a sectional view taken in a process showing a method of manufacturing the TFT substrate of the liquid crystal display in the mode for carrying out the invention;

FIG. 6 is a sectional view taken in a process showing the method of manufacturing the TFT substrate of the liquid crystal display in the mode for carrying out the invention;

FIG. 7 is a sectional view taken in a process showing the method of manufacturing the TFT substrate of the liquid crystal display in the mode for carrying out the invention;

FIG. 8 is a sectional view showing a configuration of a major part of a liquid crystal display according to Embodiment 1 in the mode for carrying out the invention;

FIG. 9 is a sectional view showing a configuration of a major part of a liquid crystal display according to Embodiment 2 in the mode for carrying out the invention;

FIG. 10 is a sectional view showing a configuration of a major part of a liquid crystal display according to Embodiment 3 in the mode for carrying out the invention; and

FIG. 11 is a sectional view showing a configuration of a major part of a liquid crystal display according to Embodiment 4 in the mode for carrying out the invention.

### DESCRIPTION OF THE PREFERRED EMBODIMENTS

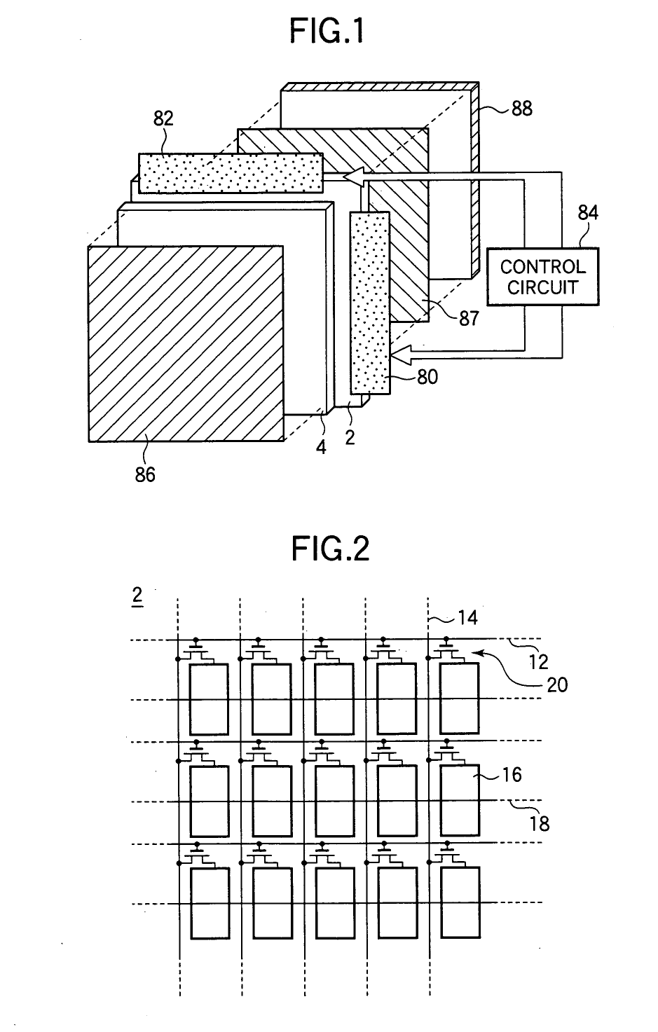

A description will now be made with reference to FIGS. 1 to 11 on a substrate for a liquid crystal display and a liquid crystal display having the same in a mode for carrying out the invention. FIG. 1 shows a schematic configuration of the liquid crystal display in the present mode for carrying out the invention. As shown in FIG. 1, the liquid crystal display has a liquid crystal display panel provided by combining a TFT substrate (base substrate) 2 having thin film transistors (TFTs) and pixel electrodes formed thereon and an opposite substrate 4 having a common electrode formed thereon in a face-to-face relationship and sealing a liquid crystal between them.

FIG. 2 shows an equivalent circuit of elements formed on the TFT substrate 2 of the liquid crystal display in the present mode for carrying out the invention. A plurality of gate bus lines 12 extending in the horizontal direction in the figure are formed on the TFT substrate 2 in parallel with each other. A plurality of drain bus lines 14 extending in the vertical direction in the figure are formed in parallel with each other such that they intersect the gate bus lines 12 with an insulation film 30 (not shown in FIG. 2) interposed therebetween. For example, each of regions surrounded by the plurality of gate bus lines 12 and drain bus lines 14 constitutes a pixel region. A TFT 20 to serve as a switching element and a pixel electrode 16 made of, for example, a transparent electrode material are formed in each pixel region. A drain electrode of each TFT 20 is connected to an adjacent drain bus line 14; a gate electrode of the same is connected to an adjacent gate bus line 12; and a source electrode of the same is connected to the pixel electrode 16. A storage capacity bus line 18 extending in parallel with the gate bus lines 12 is formed substantially in the middle of each pixel region. The TFTs 20 and the bus lines 12, 14 and 18 are formed at a photolithographic step, and they are formed through repetition of a series of semiconductor processes, i.e., film formation followed by resist application, exposure, development, etching and resist peeling.

Referring again to FIG. 1, on the TFT substrate 2 is provided with a gate bus line driving circuit 80 loaded with driver ICs for driving the plurality of gate bus lines 12 and a drain bus line driving circuit 82 loaded with driver ICs for driving the plurality of drain bus lines 14. The driving circuits 80 and 82 output scan signals and data signals to predetermined gate bus lines 12 and drain bus lines 14 based on predetermined signals output by a control circuit 84. A polarizer 87 is applied to a surface of the TFT substrate 2 that is opposite to the surface on which the elements are formed, and a backlight unit 88 is provided on the surface of the polarizer 87 opposite to the TFT substrate 2. On the contrary, a polarizer 86 is applied to a surface of the opposite substrate 4 that is opposite to the surface on which the common electrode is formed.

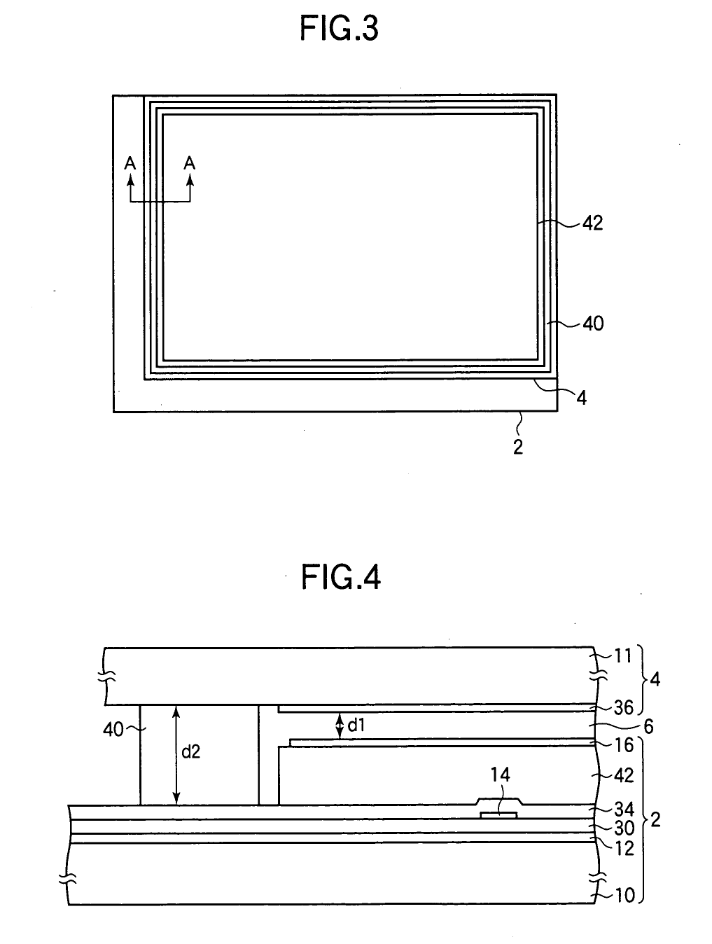

FIG. 3 shows a configuration of the liquid crystal display panel in the present mode for carrying out the invention as viewed from the side of the opposite substrate. FIG. 4 shows a sectional configuration of the liquid crystal display panel taken along the line A-A in FIG. 3 that extends along the gate bus lines 12. As shown in FIGS. 3 and 4, the TFT substrate 2 has the gate bus lines 12 which are formed on a glass substrate 10. The insulation film (gate insulation film) 30 is formed throughout the substrate over the gate bus lines 12. The drain bus lines 14 are formed on the insulation film 30. A protective film (final protective film) 34 is formed throughout the substrate over the drain bus lines 14. A cell gap control layer 42 constituted by an acrylic photosensitive resin having a thickness in the range from about 1 μm to about 3 μm (e.g., 2.6 μm) is formed in a display area that is located on the protective film 34 and inside a region in which a sealing material 40 is formed (a sealing material forming region). A pixel electrode 16 constituted by, for example, an ITO (indium tin oxide) is formed on the cell gap control layer 42 in each pixel region.

The opposite substrate 4 has a common electrode 36 in the display area on a glass substrate 11. In the present mode for carrying out the invention, since a liquid crystal display that performs color display according to the field sequential method is being described as an example, no color filter (CF) is formed. In the case of a liquid crystal display that performs color display according to the CF method, CF layers in red (R), green (G) and blue (B) are formed under the common electrode 36 in the form of stripes extending along the drain bus lines 14 on the TFT substrate 2, for example. A cell gap control layer 42 may be formed on the opposite substrate 4 under the common electrode 36.

The TFT substrate 2 and the opposite substrate 4 are combined with the sealing material 40 that is written in peripheral portions of the same. For example, the width of the sealing material 40 is about 1 mm. For example, a liquid crystal 6 having ferroelectric properties is sealed between the TFT substrate 2 and the opposite substrate 4. The surface of the TFT substrate 2 is exposed in the vicinity of two sides thereof adjacent to each other when viewed from the side of the opposite substrate 4. A plurality of TCPs (tape carrier packages) loaded with driver ICs for driving the gate bus lines 12 are mounted in an exposed region of the TFT substrate 2 that is located on the left-hand side thereof in FIG. 3. A plurality of TCPs loaded with driver ICs for driving the drain bus lines 14 are mounted in an exposed region of the TFT substrate 2 that is located at the bottom thereof in FIG. 3.

An interval d2 between the TFT substrate 2 and the opposite substrate 4 in the region where the sealing material 40 is formed is in the range from about 3.5 μm to about 5.0 μm (e.g., 4.0 μm), the interval being similar to those in common liquid crystal displays. A cell gap d1 in the display area where the cell gap control layer 42 is formed is smaller than the interval d2 (e.g., 1.4 μm). The cell gap d1 is maintained by spacers such as spherical spacers or pillar spacers (not shown in FIG. 4). In the present mode for carrying out the invention, the cell gap d1 is smaller than the thickness of the cell gap control layer 42.

In the present mode for carrying out the invention, the cell gap control layer 42 is formed in the display area that is located inside the region where the sealing material 40 is formed. As a result, the interval d2 between the substrates 2 and 4 can be relatively great in the region where the sealing material 40 is formed, and the cell gap d1 in the display area can be relatively small. Therefore, a thin picture-frame can be provided even on a liquid crystal display having a small cell gap d1 because the spreading width of the sealing material can be kept small when the two substrates are combined. Further, there is no need for reducing the amount of the sealing material 40 ejected from a dispenser, which eliminates leakage of the liquid crystal 6 attributable to breakage of the seal. The yield of manufacture of liquid crystal displays is thus improved.

Even when the liquid crystal 6 contracts in an environment at a relatively low temperature (in the range from about −20° C. to about −10° C.), the cell gap control layer 42 formed of a resin having relatively low hardness is deformed. As a result, the internal volume of the panel changes in accordance with the change in the volume of the liquid crystal to prevent generation of bubbles in the panel. Thus, even in a liquid crystal display utilizing a ferroelectric liquid crystal, display abnormalities attributable to alignment defects of the liquid crystal 6 can be prevented. It is therefore possible to provide a liquid crystal display that can achieve high display quality.

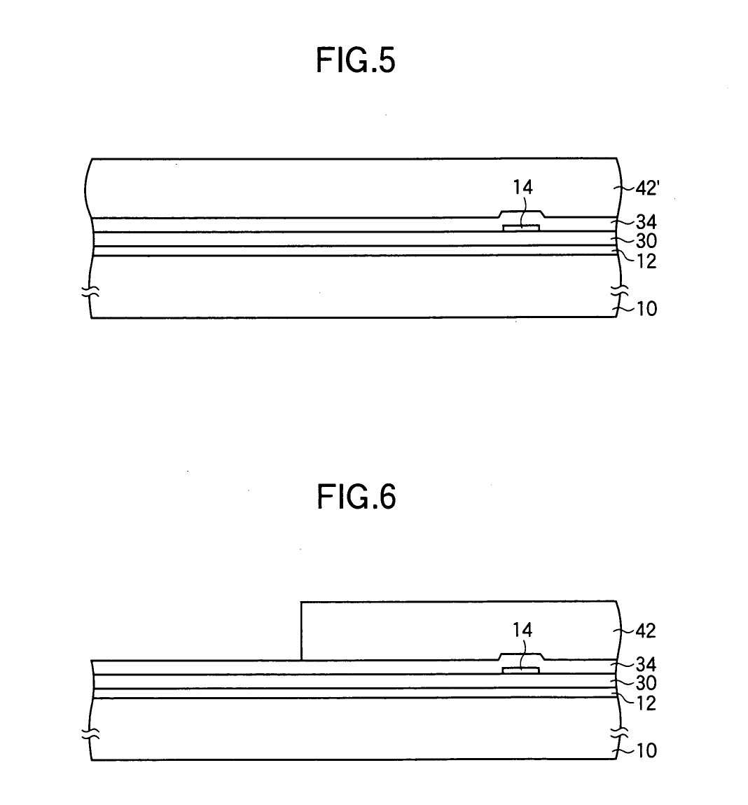

A method of manufacturing a liquid crystal display in the present mode for carrying out the invention will now be described with reference to FIGS. 5 to 7. FIG. 5 to 7 are sectional views taken in processes showing a method of manufacturing a TFT substrate of a liquid crystal display in the present mode for carrying out the invention and showing a section corresponding to that in FIG. 4. First, as shown in FIG. 5, a metal layer is formed on an entire top surface of a glass substrate 10 and patterned to form gate bus lines (gate electrodes) 12. At the same time, storage capacity bus lines 18 (not shown in FIG. 5) are formed.

For example, films of silicon nitride (SiN), amorphous silicon (a-Si) and SiN are then continuously formed throughout the substrate over the gate bus lines 12 to provide an insulation film 30, an a-Si layer and a SiN film. The SiN film is then patterned to form a channel protection film (not shown) on a self-alignment basis.

For example, an n⁺a-Si layer and a metal layer are then formed throughout the substrate over the channel protection film and patterned to form drain bus lines 14. At the same time, drain electrodes and source electrodes (both of which are not shown) of TFTs 20 are formed. TFTs 20 are thus formed. Then, for example, a film of SiN is formed throughout the substrate over the drain bus lines 14 to form a protective film 34. The protective film 34 is then patterned to form contact holes (not shown) above the source electrodes. For example, an acrylic photosensitive resin is then applied throughout the substrate over the protective film 34 to form a photosensitive resin layer 42′.

Next, as shown in FIG. 6, exposure and development is performed using a predetermined photo-mask to remove the photosensitive resin layer 42′ from a region where a sealing material 40 is to be formed and from regions outside the same. Thus, a cell gap control layer 42 is formed in a display area that is located inside the region where the sealing material 40 is formed.

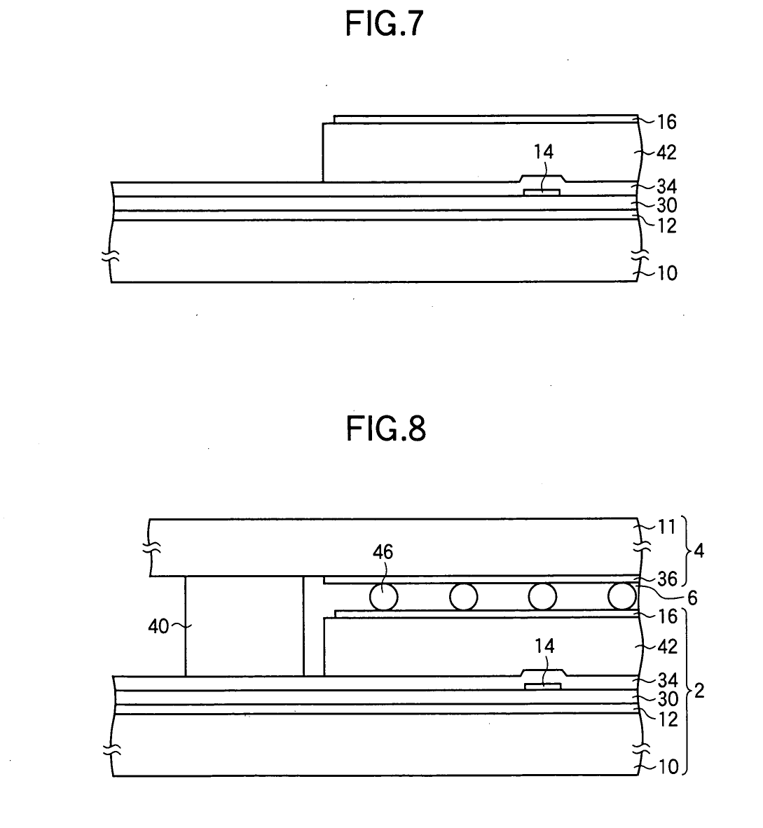

Next, for example, an ITO film is formed and patterned on the cell gap control layer 42 to form a pixel electrode 16 in each pixel region as shown in FIG. 7. A TFT substrate 2 is completed through the above-described steps. Thereafter, the sealing material is applied to and formed in a peripheral portion of either of an opposite substrate 4 which has been formed through other steps and the TFT substrate 2 to combine the substrates 2 and 4. For example, a liquid crystal having ferroelectric properties is then sealed between the substrates 2 and 4 to complete a liquid crystal display as shown in FIGS. 3 and 4.

In the present mode for carrying out the invention, since the cell gap control layer 42 is formed of a photosensitive resin, a liquid crystal display as shown in FIGS. 3 and 4 can be easily manufactured.

Specific configurations of a liquid crystal display in the present mode for carrying out the invention will now be described with reference to Embodiments 1 to 4.

(Embodiment 1)

A liquid crystal display according to Embodiment 1 in the present mode for carrying out the invention will now be described with reference to FIG. 8. FIG. 8 is a sectional view showing a configuration of a major part of the liquid crystal display of the present embodiment and showing a section corresponding to that in FIG. 4. As shown in FIG. 8, gate bus lines 12 are formed on a glass substrate 10 that constitutes a TFT substrate 2. An insulation film 30 is formed throughout the substrate over the gate bus lines 12. Drain bus lines 14 are formed on the insulation film 30. A protective film 34 is formed throughout the substrate over the drain bus lines 14. A cell gap control layer 42 constituted by an acrylic photosensitive resin having a thickness of, for example, 2.6 μm is formed in a display area that is located on the protective film 34 and inside a region where a sealing material 40 is to be formed. On the cell gap control layer 42, a pixel electrode 16 constituted by, for example, an ITO is formed in each pixel region. An opposite substrate 4 has a common electrode 36 in a display area on a glass substrate 11.

The TFT substrate 2 and the opposite substrate 4 are combined together with the sealing material 40 that is written in peripheral portions thereof. For example, the width of the sealing material 40 is about 1 mm. For example, a liquid crystal 6 having ferroelectric properties is sealed between the TFT substrate 2 and the opposite substrate 4.

The liquid crystal display has spherical spacers 46 for maintaining a cell gap. The cell gap is determined by the particle diameter of the spherical spacers 46 (which is 1.4 μm, for example). In general, spherical spacers 46 made of a resin are used in a TN mode liquid crystal display. In a liquid crystal display utilizing a ferroelectric liquid crystal, spherical spacers 46 made of silica which has high hardness and allows highly accurate control of the particle diameter are used.

In the present embodiment, the cell gap control layer 42 is formed in the display area that is located inside the region where the sealing material 40 is formed. As a result, the interval between the substrates 2 and 4 can be relatively great in the region where the sealing material 40 is formed, and the cell gap in the display area can be relatively small. Since the spreading width of the sealing material can therefore be made small when the two substrates are combined even in a liquid crystal display having a small cell gap, a thin picture-frame can be provided. Further, there is no need for reducing the amount of the sealing material 40 ejected from a dispenser, which eliminates leakage of the liquid crystal 6 attributable to breakage of the seal. The yield of manufacture of liquid crystal displays is thus improved.

Even when the liquid crystal 6 contracts in an environment at a relatively low temperature, the cell gap control layer 42 that is formed of a resin having relatively low hardness is deformed. As a result, the internal volume of the panel changes in accordance with the change in the volume of the liquid crystal to prevent generation of bubbles in the panel. Thus, even in a liquid crystal display utilizing a ferroelectric liquid crystal, display abnormalities attributable to alignment defects of the liquid crystal 6 can be prevented. It is therefore possible to provide a liquid crystal display that can achieve high display quality.

(Embodiment 2)

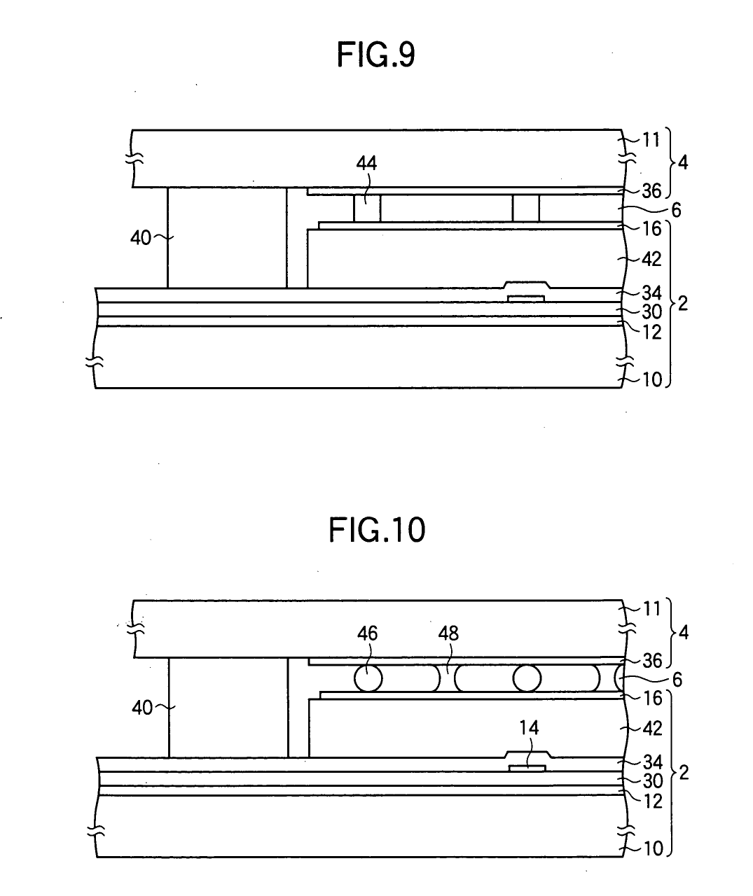

A liquid crystal display according to Embodiment 2 in the present mode for carrying out the invention will now be described with reference to FIG. 9. FIG. 9 is a sectional view showing a configuration of a major part of the liquid crystal display of the present embodiment and showing a section corresponding to that in FIG. 4. As shown in FIG. 9, gate bus lines 12 are formed on a glass substrate 10 that constitutes a TFT substrate 2. An insulation film 30 is formed throughout the substrate over the gate bus lines 12. Drain bus lines 14 are formed on the insulation film 30. A protective film 34 is formed throughout the substrate over the drain bus lines 14. A cell gap control layer 42 constituted by an acrylic photosensitive resin having a thickness of, for example, 2.6 μm is formed in a display area that is located on the protective film 34 and inside a region where a sealing material 40 is to be formed. On the cell gap control layer 42, a pixel electrode 16 constituted by, for example, an ITO is formed in each pixel region. An opposite substrate 4 has a common electrode 36 in a display area on a glass substrate 11.

The TFT substrate 2 and the opposite substrate 4 are combined together with the sealing material 40 that is written in peripheral portions thereof. For example, the width of the sealing material 40 is about 1 mm. For example, a liquid crystal 6 having ferroelectric properties is sealed between the TFT substrate 2 and the opposite substrate 4.

The liquid crystal display has pillar spacers 44 for maintaining a cell gap. The cell gap is determined by the height of the pillar spacers 44 (which is 1.4 μm, for example). The pillar spacers 44 are made of an acrylic or novolac resin and are patterned using a photolithographic process. Unlike the spherical spacers 46, the pillar spacers 44 are characterized in that they may be formed in any position such as intersections between the bus lines 12 and 14 and the entire area over the gate bus lines 12 with any shape and distribution density. The present embodiment provides the same advantages as those of Embodiment 1.

(Embodiment 3)

A liquid crystal display according to Embodiment 3 in the present mode for carrying out the invention will now be described with reference to FIG. 10. FIG. 10 is a sectional view showing a configuration of a major part of the liquid crystal display of the present embodiment and showing a section corresponding to that in FIG. 4. As shown in FIG. 10, gate bus lines 12 are formed on a glass substrate 10 that constitutes a TFT substrate 2. An insulation film 30 is formed throughout the substrate over the gate bus lines 12. Drain bus lines 14 are formed on the insulation film 30. A protective film 34 is formed throughout the substrate over the drain bus lines 14. A cell gap control layer 42 constituted by an acrylic photosensitive resin having a thickness of, for example, 2.6 μm is formed in a display area that is located on the protective film 34 and inside a region where a sealing material 40 is to be formed. On the cell gap control layer 42, a pixel electrode 16 constituted by, for example, an ITO is formed in each pixel region. An opposite substrate 4 has a common electrode 36 in a display area on a glass substrate 11.

The TFT substrate 2 and the opposite substrate 4 are combined together with the sealing material 40 that is written in peripheral portions thereof. For example, the width of the sealing material 40 is about 1 mm. For example, a liquid crystal 6 having ferroelectric properties is sealed between the TFT substrate 2 and the opposite substrate 4.

The liquid crystal display has spherical spacers 46 for maintaining a cell gap and an adhesive 48 for firmly securing the substrates 2 and 4 to each other. For example, the adhesive 48 is an epoxy type thermoset resin and is in the form of particles having a particle diameter in the range from about 2 μm to about 6 μm before it is set. The adhesive 48 is spread on either of the substrates 2 and 4 concurrently with or separately from the dispersion of the spherical spacers 46. Thereafter, the substrates 2 and 4 are combined and heated to a temperature of about 200° C. with a pressure applied thereto. The adhesive 48 is thus set with a predetermined cell gap maintained.

In general, when a pressure is applied to the substrate surface in a certain region from the outside, the liquid crystal 6 in that region moves to other regions. As a result, the cell gap decreases in that region and increases in the other regions. In the present embodiment, however, since the substrates 2 and 4 are firmly secured to each other by the adhesive 48 to prevent expansion of the cell gap, the cell gap does not decrease in any region even when a pressure is applied to the substrate surface in that region from the outside. Therefore, the present embodiment provides the same advantages as those of Embodiment 1 and further reduces the possibility of fluctuations of a cell gap, which makes it possible to prevent display abnormalities of a liquid crystal display utilizing a ferroelectric liquid crystal.

(Embodiment 4)

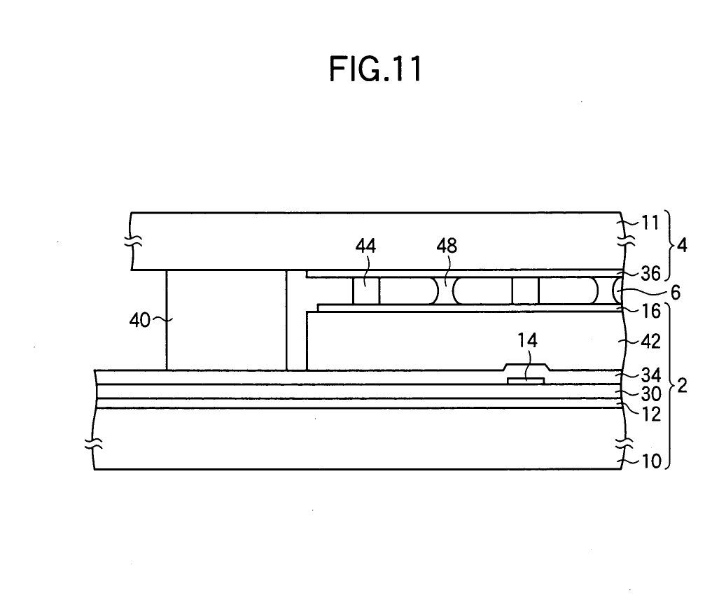

A liquid crystal display according to Embodiment 4 in the present mode for carrying out the invention will now be described with reference to FIG. 11. FIG. 11 is a sectional view showing a configuration of a major part of the liquid crystal display of the present embodiment and showing a section corresponding to that in FIG. 4. As shown in FIG. 11, gate bus lines 12 are formed on a glass substrate 10 that constitutes a TFT substrate 2. An insulation film 30 is formed throughout the substrate over the gate bus lines 12. Drain bus lines 14 are formed on the insulation film 30. A protective film 34 is formed throughout the substrate over the drain bus lines 14. A cell gap control layer 42 constituted by an acrylic photosensitive resin having a thickness of, for example, 2.6 μm is formed in a display area that is located on the protective film 34 and inside a region where a sealing material 40 is to be formed. On the cell gap control layer 42, a pixel electrode 16 constituted by, for example, an ITO is formed in each pixel region. An opposite substrate 4 has a common electrode 36 in a display area on a glass substrate 11.

The TFT substrate 2 and the opposite substrate 4 are combined together with the sealing material 40 that is written in peripheral portions thereof. For example, the width of the sealing material 40 is about 1 mm. For example, a liquid crystal 6 having ferroelectric properties is sealed between the TFT substrate 2 and the opposite substrate 4.

The liquid crystal display has pillar spacers 44 for maintaining a cell gap and an adhesive 48 for firmly securing the substrates 2 and 4 to each other. For example, the adhesive 48 is an epoxy type thermoset resin and is in the form of particles having a particle diameter in the range from about 2 μm to about 6 μm before it is set. The adhesive 48 is spread on either of the substrates 2 and 4 prior to a combining step. Thereafter, the substrates 2 and 4 are combined and heated to a temperature of about 200° C. with a pressure applied thereto. The adhesive 48 is thus set with a predetermined cell gap maintained. The present embodiment provides the same advantages as those of Embodiment 3.

As described above, in the present mode for carrying out the invention, a manufacturing method substantially similar to those in the related art can be used for a liquid crystal display having an extremely small cell gap. According to Embodiments 3 and 4 in the present mode for carrying out the invention, a liquid crystal display that is rigid against external pressures can be provided without any adverse effect on display quality even when a liquid crystal material such as a ferroelectric liquid crystal that is quite sensitive to external pressures is used.

The invention is not limited to the above-described mode for carrying out the same and may be modified in various ways.

For example, while liquid crystal displays utilizing a ferroelectric liquid crystal have been referred to as examples in the above-described mode for carrying out the invention, the invention is not limited to them and may be applied to other liquid crystal displays such as TN mode displays utilizing a nematic liquid crystal.

While transmissive liquid crystal displays have been referred to as examples in the above-described mode for carrying out the invention, the invention is not limited to them and may be applied to other liquid crystal displays such as reflective and transflective displays.

While active matrix liquid crystal displays have been referred to as examples in the above-described mode for carrying out the invention, the invention is not limited to them and may be applied to passive matrix liquid crystal displays.

As described above, the invention makes it possible to provide a liquid crystal display which is manufactured with improved yield and which can achieve high display quality.

What is claimed is:

1. A substrate for a liquid crystal display, comprising:
a sealing material forming region provided in a peripheral portion of the base substrate; and
a cell gap control layer formed inside the sealing material forming region and controlling a cell gap between the base substrate and an opposite substrate provided opposite to the base substrate.

2. A substrate for a liquid crystal display according to claim 1, wherein the cell gap control layer is formed of a photosensitive resin.

3. A liquid crystal display comprising a pair of substrates and a liquid crystal sealed between the substrates, wherein a substrate for a liquid crystal display according to claim 1 is used as either of the substrates.

4. A liquid crystal display according to claim 3, further comprising an adhesive which is spread on either of the substrates and which secures the pair of substrates to each other.

5. A liquid crystal display according to claim 3, further comprising a pillar spacer for maintaining the cell gap.

6. A liquid crystal display according to claim 3, further comprising a spherical spacer for maintaining the cell gap.

7. A liquid crystal display according to claim 3, wherein the cell gap control layer has a thickness greater than the cell gap.
